(19) United States
(12) Patent Application Publication
(10) Pub. No.: US 2005/0279818 A1
(43) Pub. Date: Dec. 22, 2005

(54) System and method for inducing use of services

(75) Inventors: Dean Del Prete, West Hampton, NY (US); Paul Sattler, Farmingville, NY (US); Louis J. Braun, Chappaqua, NY (US)

Correspondence Address: HOFFMANN & BARON, LLP, 6900 JERICHO TURNPIKE, SYOSSET, NY, 11791, US

(73) Assignee: Cousins Management Group

(21) Appl. No.: 10/869,625

(22) Filed: Jun. 16, 2004

(51) Int. Cl. G06F 17/00

(52) U.S. Cl. 235/375

(57) ABSTRACT

Systems and methods for inducing use of services are disclosed. The system includes a display for displays at least one ticket for use of offered services, at least one ticket for the service fixed to the display and a holder which holds the ticket-bearing display for removal from the holder, whereby a retailer induces use of the services to customers viewing the system. The method includes providing at least one ticket-bearing display, which includes at least one ticket for the service, in a system which advertises the service at a retailer location; and selling the system to the retailer at a cost which permits the retailer to obtain a profit by selling the ticket-bearing display to a consumer.

### BACKGROUND OF THE INVENTION

1. Field of the Invention

The present invention relates generally to advertising, and in particular to advertising systems or materials and methods for promoting use of services.

2. Description of the Prior Art

Advertising is a major part of the economy. It plays a significant role in the solicitation of customers for a wide range of commercial enterprises providing various types of goods and services.

The overall objective of an advertising campaign is generally to sell the goods and/or services of the advertiser. The normal strategy for accomplishing this objective is to communicate with customers and potential customers, thereby inducing purchases through a combination of information and persuasion.

A significant challenge faced by advertisers is attracting the attention of prospective customers. Various advertising techniques have been developed to attract the attention of potential customers. Discounted pricing is a common example and can take many forms. For example, reduced-price “sales” are extensively and repeatedly conducted by many mass merchandisers. Discount coupons are also extensively used in merchandising. A typical discount coupon allows a purchaser to obtain a given product at a reduced price, or provides some additional consideration. Rebates comprise yet another form of price discounting.

However, heretofore there has not been available an advertising system and method which both advertises a service at a retailer or mass merchandiser location and directly provides a profit to the retailer or mass merchandiser by selling the advertising material itself.

### SUMMARY OF THE INVENTION

In the practice of the present invention, a system is provided for inducing use of services. The system includes a display for displaying at least one ticket for use of offered services; at least one ticket for the services fixed to the display; and a holder which holds the ticket-bearing display for removal from the holder, whereby a retailer induces use of the services to customers viewing the system.

Preferably, the display also includes advertising relating to the services provided by the ticket(s). The advertising can include indicia on the display or objects mounted in or on the display. Preferably, the indica is included on an advertising insert.

In one embodiment, the display includes a sheltering container which is a barrier surrounding the ticket(s) and the insert. The container can be a rigid plastic container. Preferably, the rigid plastic container substantially surrounds the insert and the ticket(s).

In a preferred embodiment, the display must be destroyed in order to remove the ticket(s). The display can have a substantially flat configuration. It is preferred that there is more than one ticket fixed to the display, e.g., a group of 5, 10 or 20 tickets. It is also contemplated that the ticket(s) is/are destroyed when removed from the display by a consumer. Preferably, the system includes multiple displays. More preferably, multiple essentially identical displays.

In one embodiment, the holder is a rigid material. The holder can be a plastic material. Preferably, the holder also includes at least one substantially vertical slot for holding the ticket bearing display in a substantially vertical position for viewing.

In one embodiment, the tickets are admission tickets for a non-date specific entertainment event. In another embodiment, the tickets are vouchers that can be redeemed for admission tickets to a date specific event.

In a preferred embodiment, the display further includes a first sheet of the display having a front and back surface; a second sheet of the display attached adjacent to the front surface of the first sheet, the second sheet forming a cavity therein for accepting the ticket(s), wherein the first sheet and second sheet form a container for securing the ticket(s) so that they cannot be removed without cutting either the first or second sheet; and an insert containing indicia relating to the services, wherein the insert is held between the first sheet and second sheet. Preferably, the first sheet and the second sheet are made of a transparent material.

In another aspect, the invention is directed to a system for inducing use of services which includes at least one ticket for providing a non-date specific service; and a display for containing the ticket(s), which includes advertising related to the services provided by the ticket(s). The system can also include a holder which holds the ticket bearing display for removal from the holder, whereby a retailer induces use of the services to customers viewing the system. In one embodiment, the holder is a rod extending substantially perpendicular from a vertical surface. In such an embodiment, the display can include an aperture for accepting the rod from the holder so that the display is suspended therefrom.

In the practice of the method of the present invention, an advertiser provides at least one ticket-bearing display, which includes at least one ticket for a service, in a system which advertises the service at a retailer location; and sells the system to the retailer at a cost which permits the retailer to obtain a profit by selling the ticket-bearing display to a consumer. The method allows both the advertiser and the retailer to obtain income while advertising a service. Preferably, the retailer does not offer the service being advertised.

The service can be offered at one or more fixed locations. In one embodiment, the service is offered at more than one fixed location and the service locations are identified on the ticket, the display or both. In another embodiment, the service is offered at more than one fixed location and the service locations are identified by calling a telephone number or visiting an internet web site listed on the ticket, the display or both.

The service can be selected from the group consisting of an entertainment event, personal care service and property care service. Preferably, the entertainment event includes customer participation. Examples of such an event include a paintball game or competition, skateboarding, in-line skating, roller skating, golf, a driving range, miniature golf, shooting sports, laser tag, theme or amusement parks, horseback riding, skiing, bowling or camping.

Preferably, the entertainment event is offered with at least one additional service or good at a cost that is in addition to the cost of the ticket. More preferably, the consumer is required to purchase at least one additional service or good at a cost that is in addition to the cost of the ticket, in order to participate in the entertainment event. In one embodiment, the entertainment event is a paintball game or competition and the additional service or good is selected from the group consisting of CO₂ cartridges and paintballs.

In another embodiment, the entertainment event is a spectator event. Examples of such an event include sporting events, movies, plays, theatrical or musical performances, museums and comedy shows. The spectator event can be a date specific event. In such an embodiment, the ticket is preferably a voucher that can be redeemed for an admission ticket to the date specific event.

In one embodiment, the service is a personal care service selected from the group consisting of beauty salon treatments or services and spa treatments. In another embodiment, the service is a property care service selected from automobile care services and pet care services. Examples of auto care services are oil changes, car washes and car detailing. Examples of pet care services are pet cleaning, boarding and grooming.

In one embodiment of the invention, the ticket permits the consumer to enter a facility offering the service. Preferably, the retailer sells the ticket at a price less than the typical entrance fee for the service.

In an embodiment of the invention, the system includes: (1) at least one ticket fixed to a display which advertises the service and (2) a holder which holds the ticket bearing display for removal from the holder, whereby the retailer provides the system at a surveillable location for viewing and purchase by the consumer. Preferably, the display includes multiple tickets. More preferably, the display includes a group of 5, 10 or 20 tickets.

Preferably, the retailer has a customer base which includes customer demographics suitable for advertising the service. The retailer preferably sells goods that are related to or used in connection with the service.

In another aspect the invention is directed to a symbiotic advertising method, in which both the advertiser and the retailer benefit. The method involves providing at least one ticket-bearing display, which includes at least one ticket for a service, in a system which advertises the service at a retailer location; and selling the system to the retailer at a cost which permits the retailer to obtain a profit by selling the ticket-bearing display to a consumer, wherein the ticket is applicable to multiple service providers or to no specific service providers. Preferably, the retailer is not a service provider, i.e., does not offer the service being advertised.

In one embodiment, the service provider offers the service at one or more fixed locations. Preferably, the ticket is applicable to different service providers which offer the service at different locations.

The service can be selected from the group consisting of an entertainment event, personal care service and property care service. Preferably, the entertainment event includes customer participation. Examples of such an entertainment event include a paintball game or competition, skateboarding, in-line skating, roller skating, golf, a driving range, miniature golf, shooting sports, laser tag, theme or amusement parks, horseback riding, skiing, bowling or camping.

Preferably, the service provider offers at least one additional service or good at a cost that is in addition to the cost of the ticket. More preferably, the service provider requires the purchase of at least one additional service or good at a cost that is in addition to the cost of the ticket, in order to participate in the entertainment event. In one embodiment, the entertainment event is a paintball game or competition and the additional service or good is selected from the group consisting of CO₂ cartridges and paintballs.

In one embodiment, the ticket permits the consumer to enter a facility offering the service. Preferably, the retailer sells the ticket at a price less than the typical entrance fee for the service.

In an embodiment of the invention, the system includes: (1) at least one ticket fixed to a display which advertises the service and (2) a holder which holds the ticket bearing display for removal from the holder, whereby the retailer provides the system at a surveillable location for viewing and purchase by the consumer. Preferably, the display includes multiple tickets. More preferably, the display includes a group of 5, 10 or 20 tickets.

The retailer preferably has a customer base which includes customer demographics suitable for advertising the service. Preferably, the retailer sells goods that are related to or used in connection with the service.

In one embodiment, the participating service provider locations are identified by calling a telephone number or visiting an internet web site listed on the ticket, the advertising system or both. In another embodiment, the method includes selling subscriptions to the service providers to participate in the advertising.

In another aspect, the invention is directed to a method of inducing attendance of an entertainment event. The method includes providing at least one retailer with at least one ticket for the entertainment event at a reduced cost for sale to a consumer, whereby the retailer makes a profit based on the sale price to the consumer less the reduced cost and wherein the retailer operates out of one or more fixed locations which are open to the public and which offer for sale other goods or services.

The entertainment event is preferably a spectator event selected from the group consisting of sporting events, movies, plays, theatrical or music performances, museums and comedy shows. In one embodiment, the ticket is an admission ticket to the event. The ticket can be a general admission ticket.

In one embodiment, the event is held at a specific venue and the ticket permits access to specific locations within said venue. The sale price of the ticket can vary depending on the locations to which the ticket permits access.

In another embodiment, the ticket is a voucher that can be redeemed for an admission ticket to a date specific event. In such an embodiment, the admission ticket is preferably for an assigned seat. The sale price of the voucher can vary depending on the location of the assigned seats. The sale price of the voucher can also vary depending on the anticipated popularity of the event. Preferably, the date specific event is a sporting event.

Additional objects, advantages and novel features of the invention will be set forth in part in the description which follows, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE FIGURES

FIG. 1 is a front perspective view of a system for inducing use of services according to a preferred embodiment of the present invention, showing one display and a holder.

FIG. 2 is a cross-sectional view of the system of FIG. 1.

FIG. 3 is a rear elevational view of a display depicting advertising indica which includes specific service provider locations.

FIG. 4 is an exploded perspective view of the system depicting a display prior to assembly and a holder.

### DETAILED DESCRIPTION OF THE INVENTION

The present invention provides an advertising system for inducing use of services. The system includes a display for displaying at least one ticket for use of offered services, at least one ticket for the services fixed to the display, and a holder which holds the ticket-bearing display for removal from the holder. A retailer induces use of the offered services to customers viewing and purchasing the display.

The present invention is also directed to a method for obtaining income while advertising a service. The method includes providing at least one ticket for the service in a system which advertises the service at a retailer location and selling the system to the retailer at a cost which permits the retailer to obtain a profit by selling ticket-bearing displays to a consumer. The ticket(s) can be applicable to multiple service providers or to no specific service providers. In this way the same system can be utilized by mass merchants in various locations.

By the term “ticket” is meant an actual admission ticket that permits a consumer to use the service being advertised or a voucher that the consumer can redeem or exchange for an actual admission ticket. Thus, it is contemplated that the ticket fixed to the display can be directly presented in exchange for use of a service. Examples of such tickets include general admission tickets to a spectator event, such as a movie, or admission tickets that allow a person to participate in a participation event, such as playing paintball. It is also contemplated that the ticket fixed to the display can be a voucher that can be redeemed or exchanged for an admission ticket for use of a service. Examples of such tickets include vouchers that can be exchanged for an admission ticket to a spectator event that has an assigned seat for the event, such as a sporting event.

By the terminology “fixed to a display” is meant that the ticket(s) is/are attached to, an integral part of, or contained in the display. The ticket(s) can be releasably attached to the display, e.g., by a pressure sensitive adhesive. The ticket(s) can also be contained within a shell, e.g., within clamshell packaging, as known in the industry.

I. The Advertising System

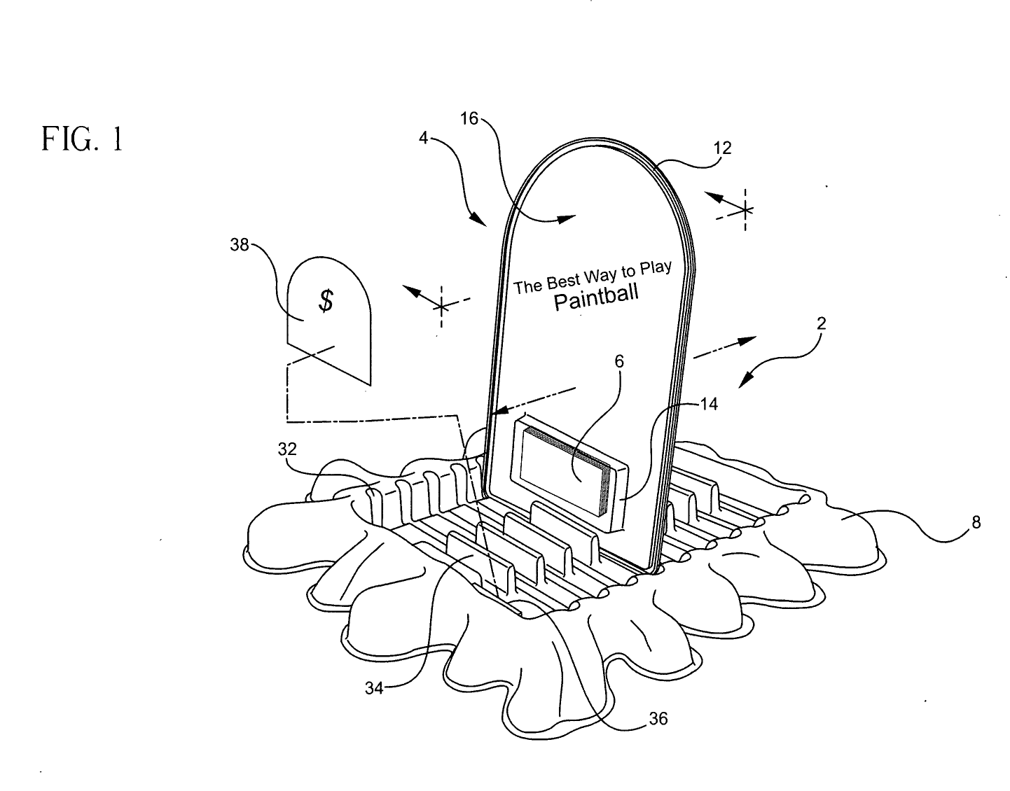

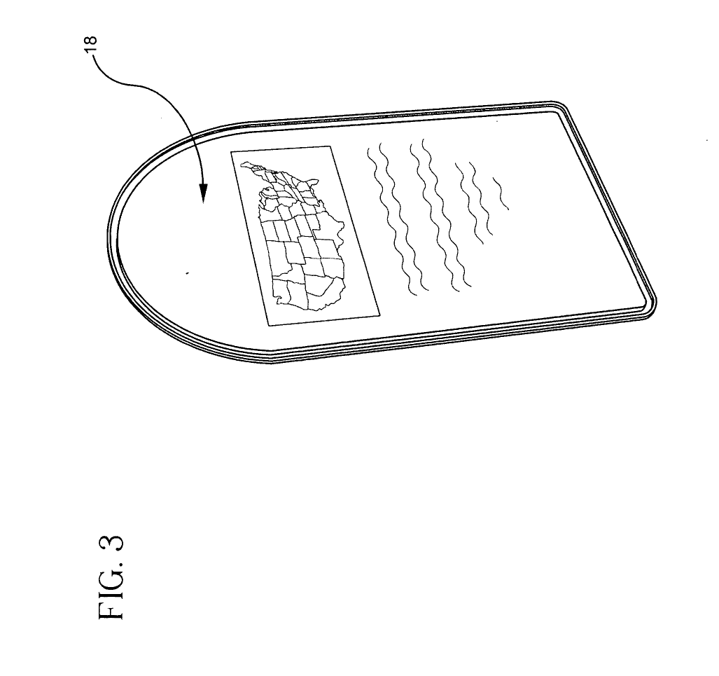

In a preferred embodiment, the invention provides an advertising system for inducing use of services that includes a display for displaying at least one ticket for use of an offered service and a holder which is capable of holding multiple ticket-bearing displays for removal from the holder. Referring to the drawings there is shown in FIGS. 1-4 a system 2 for inducing use of services. The system 2 includes a display 4 for displaying at least one ticket 6 for use of an offered service and a holder 8 which holds the ticket-bearing display 4 for removal from the holder 8. The system 2 can be sold to a retailer for display in a retail store and for subsequent sale of the display 4 to a consumer interested in using (or participating in) the offered service(s). The retailer thereby induces use of the service(s) to consumers viewing the system 2 and purchasing the display 4.

The display 4 includes advertising and other information relating to the service(s) provided by the ticket(s) 6. The advertising/information includes indicia provided on an insert 10 contained within the display 4. The display 4 also includes a sheltering container 12 which is a barrier surrounding the ticket(s) 6 and the insert 10. The sheltering container 12 is a continuous container which includes a cavity 14 for accepting or holding the ticket(s) 6. The container 12 is preferably transparent so that the advertising/information indica on the insert 10 can be viewed through the front face 16 of the display 4. Additional advertising or other information relating to the service(s) can be provided on the insert 10 so that it can be viewed through the rear face 18 of the display 4. Preferably, the rear facing surface of the insert, i.e. the surface viewable through the rear face 18 of the display, includes information relating to specific service provider locations.

The container 12 is a rigid transparent container made from a transparent synthetic resin (i.e., polymeric or plastic material). Typical polymeric materials include organic transparent polymers which can be molded, using conventional molding techniques, such as polyethylene, polypropylene, polystyrene, methacrylates, polyparamethyl styrene and the like. Coated plastic materials, which have coatings to improve the surface characteristics or esthetic appearance of the container, such as inorganic coatings, are also contemplated.

In other embodiments it is contemplated that the advertising/service information is provided on the front face 16, the rear face 18 or both faces of the display 4 itself or on objects mounted on the display 4, e.g., stickers or labels. In such embodiments, the display 4 may not include an insert and the container can be made from an opaque material. It is also contemplated that the container can be discontinuous, or a combination of transparent and opaque materials, with openings or windows revealing the indicia on the insert.

The display 4 is preferably constructed so that it must be destroyed or permanently altered to remove the ticket(s) 6 from the display 4. More specifically, the integrity of the continuous container 12 having the cavity 14 for the ticket(s) 6 must be compromised to remove the ticket(s) 6.

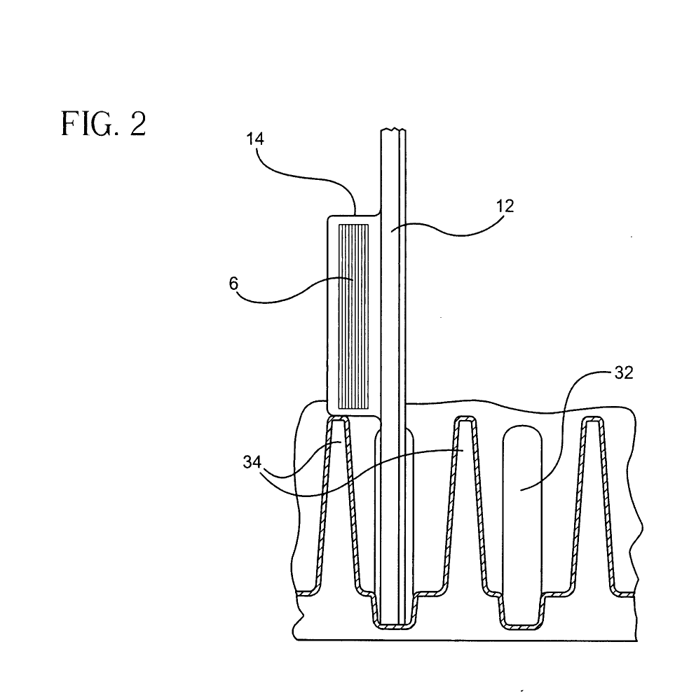

The display 4 has a substantially flat configuration as shown in FIG. 2. This allows multiple displays 4 to be provided in a relatively small area in the retail space. The display 4 preferably includes multiple tickets 6. Preferably, the tickets 6 are provided in groups of 5, 10 or 20 tickets. In other embodiments, it is contemplated that the display will include one ticket that will allow admission to or participation in the service for multiple consumers or for the same consumer multiple times. This can be accomplished with punch type tickets or electronically coded tickets.

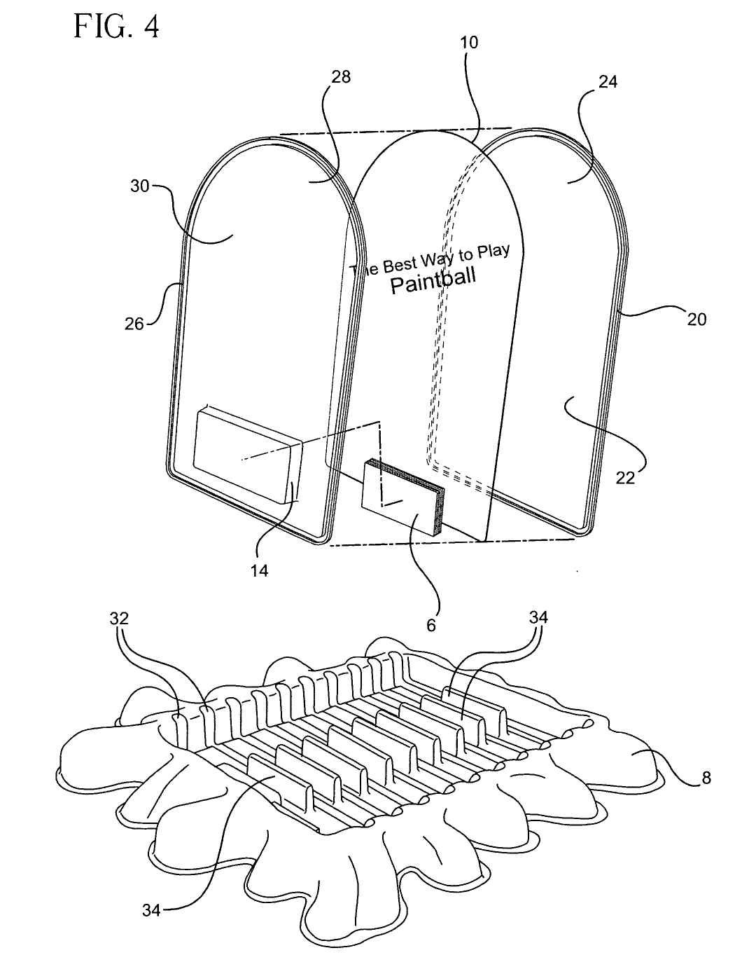

Referring to FIG. 4, the display 4 includes a first sheet 20, having an inner surface 22 and a outer surface 24; and a second sheet 26, having an inner surface 28 and an outer surface 30, attached to the first sheet so that the inner surface 22 of the first sheet 20 is adjacent to the inner surface 28 of the second sheet 26. The second sheet includes a cavity 14 for accepting the ticket(s) 6. The attached sheets form the container 12 for securing the ticket(s) 6 and the advertising insert 10, so that they cannot be removed without cutting either the first sheet 20 or second sheet 26. The insert is held between the inner surface 22 of the first sheet 20 and the inner surface 28 of the second sheet 26 and the tickets are held within the cavity 14 and against the insert 10.

Preferably, the system 2 includes multiple displays 4. More preferably, the system 2 includes multiple essentially identical displays 4. Accordingly, the holder 8 is capable of holding multiple displays 4.

The holder 8 is made of a rigid material capable of holding multiple displays 4 in a substantially vertical alignment for viewing by the consumer. The holder 8 can be made from typical synthetic materials (i.e. polymeric or plastic material) used in conventional molding techniques, such as injection molding, vacuum forming or rotational molding. The holder 8 includes at least one substantially vertical slot 32 for holding the ticket-bearing display 4 in a substantially vertical position for viewing and removal by a consumer wishing to purchase the display 4. The holder 8 also includes a vertical rib 34 adjacent to the slot 32 which provides support for the display 4 underneath the ticket cavity 14 and assists in holding the display 4 in a substantially vertical position. The holder 8 also includes a vertical slot 36 for holding a card 38 that indicates the price for a display unit 4.

In other embodiments, the holder can include a means for holding additional advertising or service information materials. This can be in the form of additional slots for holding cards or inserts which contain advertising or service information indicia. The holder can also include a rod extending substantially perpendicular from a vertical service. In such an embodiment, the display can include an aperture for accepting the rod from the holder so that the display is suspended therefrom.

II. Symbiotic Advertising Methodology

An advertising method using the advertising system 2 is disclosed. An advertiser provides at least one ticket-bearing display, which includes at least one ticket for a service, in a system which advertises the service at a retailer location; and sells the system to the retailer at a cost which permits the retailer to obtain a profit by selling the display to a consumer. The retailer offers the ticket-bearing displays to customers by placing the system at a surveillable location in the retail establishment for viewing and purchase by the consumer. The method allows both the advertiser and the retailer to obtain income while advertising a service.

An advertiser can be any entity with a service to sell or promote, e.g., a service provider. The advertiser can involve a promoter, sales representative, distributor or the like to help place the advertising system 2 in a retail establishment. Since the retail entities sell the displays 4 provided with the system 2 in order to generate revenue and also to increase traffic in their establishments, the retailers comprise a second or additional advertiser whereby a symbiotic relationship is created, with the advertiser advertising its service(s) while generating revenue and with the retailer obtaining revenue by selling the ticket-bearing displays 4 and increasing traffic for related goods. In addition, the increased attendance of (or participation in) the service will provide the service provider with an opportunity to sell additional goods or services and will provide the retailer with an opportunity to sell additional goods related to the offered service.

Customers of the retailer can include purchasers of the ticket-bearing displays 4. Thus, the retailers can be carefully chosen for their customer profiles and demographics. For example, the services of the advertiser can be matched with retailers whose customers would be most likely to purchase tickets for the advertised services. For example, the advertised services can correspond to the goods and/or services of the retailer whereby the advertised services are offered to a targeted group of potential customers. Moreover, retailers with multiple retail store locations can carry the system 2, and can distribute the system according to the demographics of their various locations. Preferably, the retailer does not offer the service being advertised, but does offer goods that are related to or used in connection with the service.

At the retail level the ticket-bearing displays 4 are sold to the retail customers. The retailers can participate in the promotion of the services by displaying the system 2, as well as by various other advertising methodologies, including print, broadcast media, direct mail, etc., to promote sales of the ticket(s) 6 for the offered services. Since the ticket(s) 6 contained in the ticket-bearing display 4 typically has/have a value in excess of the retail purchase price, the customers are enticed to use (or participate in) the offered services. Moreover, the customers are enticed to purchase related goods from the retailer.

The service can be offered at one or more fixed locations. In one embodiment, the service is offered at more than one fixed location and the service locations are identified on the ticket, the ticket-bearing display (e.g. the rear facing side of the insert 10) or both. In another embodiment, the service is offered at more than one fixed location and the service locations are identified by calling a telephone number or visiting an internet web site listed on the ticket, the ticket-bearing display or both.

The service can be selected from the group consisting of an entertainment event, personal care service and property care service. Preferably, the entertainment event includes customer participation. Examples of customer participation events include a paintball game or competition, skateboarding, in-line skating, roller skating, golf, golf driving range, miniature golf, shooting sports, laser tag, theme or amusement parks, horseback riding, skiing, bowling or camping.

Preferably, the entertainment event is offered with at least one additional service or good at a cost that is in addition to the cost of the ticket. More preferably, the consumer is required to purchase at least one additional service or good at a cost that is in addition to the cost of the ticket, in order to participate in the entertainment event. For example, the entertainment event can be a paintball game or competition and the additional service or good provided by the service provider can be selected from the group consisting of CO₂ cartridges and paintballs.

In another embodiment, the entertainment event is a spectator event. Examples of spectator events include sporting events, movies, plays, theatrical or musical performances, museums, comedy shows and other live entertainment.

In one embodiment, the service is a personal care service selected from the group consisting of beauty salon treatments or services and spa treatments. In another embodiment, the service is a property care service selected from automobile care services and pet care services. Examples of auto care services are oil changes, car washes and car detailing. Examples of pet care services are animal grooming, boarding and washing.

In one embodiment of the invention, the ticket(s) 6 permit(s) consumers to enter a facility offering the service. Preferably, the retailer sells the ticket(s) 6 at a price less than the typical entrance fee for the service. Preferably, the display 4 includes multiple tickets 6. More preferably, the display includes groups of 5, 10 or 20 tickets.

In one specific embodiment, the invention is directed to a method of inducing attendance of an entertainment event. The method includes providing at least one retailer with at least one ticket for the entertainment event at a reduced cost for sale to a consumer, whereby the retailer makes a profit based on the sale price to the consumer less the reduced cost and wherein the retailer operates out of one or more fixed locations which are open to the public and which offer for sale other goods or services. Preferably, the sales price to the consumer is less than a typical admission ticket price.

In one embodiment, the entertainment event is a spectator event, preferably, a sporting event. In such an embodiment, the ticket can be in the form of a voucher or an actual admission ticket to the event. The voucher can be exchanged at a later time for an admission ticket to a date specific event.

By date specific event is meant that the service provider offers or sells admission tickets that are applicable to an event that is held on a specific date and time. Although the voucher would not be limited to being used for a specific date, the voucher would be redeemed or exchanged for an admission ticket that is date specific.

The sale price can be one fixed price for a given event, e.g., a general admission ticket. It is also contemplated that the sale price can vary for a given event depending on the location of seating for the event or the location to which the ticket will allow access. For example, the sale price can vary by seating section or level, with more desirable locations having a higher sale price. In such an embodiment, the method can include providing tickets for sale at one sale price (e.g., for a particular seating section(s) or level(s)) or can include providing tickets for sale at different sales prices for a given event. If different sales prices are offered, the consumer can select and purchase tickets at a certain sale price.

It is also contemplated that the sale price can vary for different events at the same venue, depending upon the popularity of the specific event. In such an embodiment, the method can include providing tickets for sale at one sale price for one particular event or a selected group of events, or can include providing tickets for sale at different sales prices for different events. The different sales prices can vary by specific individual events or categories of events. The categories can include different categories of selected groups of events and the sale price can vary for each category depending on the anticipated popularity of each group of events. For example, tickets for a particular baseball team can be provided at different sales prices based on the popularity of the specific game or groups of games, based on, for example, the opponent, promotional giveaways, other promotional events (e.g. fireworks, old timers day, etc.), playoff games, etc.

In an embodiment where the ticket is a voucher for a date specific event, it is also contemplated that the voucher can be redeemable for an admission ticket for the best available seat for a given date. If no seats are available for a given date, the voucher can be used for another date that has available seats.

In industries involving services that are offered at fixed locations, a major concern or goal is to attract customers to visit the location and use (or participate in) the service. Accordingly, it is common practice for such service providers to honor coupons or advertisements for reduced or free admission from any and all competitors, in the hope that the service provider will receive repeat business and/or will be able to sell additional goods or services to the customer presenting a competitor's coupon or advertisement.

As such, the ticket(s) 6 provided in accordance with the present invention can be applicable to multiple (or different) service providers or to no specific service providers, even though the service providers may be direct competitors. Moreover, different service providers that offer the same or similar services at locations in different geographical areas can be included in the advertising according to the present invention. In such a case, the methods according to the invention can include selling subscriptions to different service providers to participate in the advertising. This is particularly applicable to an advertising system that can be sold to mass merchandisers and that is applicable to different service provider locations nationwide.

Thus, while there has been disclosed what is presently believed to be the preferred embodiments of the invention, those skilled in the art will appreciate that other and further changes and modifications can be made without departing from the scope or spirit of the invention, and it is intended that all such other changes and modifications are included in an are within the scope of the invention as described in the appended claims.

1. A system for inducing use of services comprising:
a display for displaying at least one ticket for use of offered services;
at least one ticket for said services fixed to said display; and
a holder which holds said ticket-bearing display for removal from said holder, whereby a retailer induces use of said services to customers viewing said system.

2. A system for inducing use of services as defined in claim 1, wherein said display further comprises advertising relating to the services provided by the at least one ticket.

3. A system for inducing use of services as defined in claim 2, wherein said advertising comprises indicia on said display.

4. A system for inducing use of services as defined in claim 2, wherein said advertising comprises indicia on an object mounted on said display.

5. A system for inducing use of services as defined in claim 2, wherein said advertising comprises indicia on an object mounted in said display.

6. A system for inducing use of services as defined in claim 5, wherein said object is an advertising insert.

7. A system for inducing use of services as defined in claim 1, wherein said display comprises a sheltering container which is a barrier surrounding said at least one ticket.

8. A system for inducing use of services as defined in claim 7, wherein said container is a rigid plastic container.

9. A system for inducing use of services as defined in claim 8, wherein said rigid plastic container substantially surrounds said at least one ticket and an advertising insert.

10. A system for inducing use of services as defined in claim 1, wherein said display must be destroyed in order to remove said at least one ticket.

11. A system for inducing use of services as defined in claim 1, wherein said display has a substantially flat configuration.

12. A system for inducing use of services as defined in claim 1, wherein there is more than one ticket fixed to said display.

13. A system for inducing use of services as defined in claim 1, wherein said at least one ticket is destroyed when removed from said display by a consumer.

14. A system for inducing use of services as defined in claim 1, wherein said system comprises multiple displays.

15. A system for inducing use of services as defined in claim 1, wherein said holder is a rigid material.

16. A system for inducing use of services as defined in claim 15, wherein said holder is plastic.

17. A system for inducing use of services as defined in claim 15, wherein said holder further includes at least one substantially vertical slot for holding said ticket bearing display in a substantially vertical position for viewing.

18. A system for inducing use of services as defined in claim 1, wherein said at least one ticket is an admission ticket for a non-date specific event.

19. A system for inducing use of services as defined in claim 1, wherein said at least one ticket is a voucher which can be redeemed for an admission ticket to a date specific event.

20. A system for inducing use of services as defined in claim 1, wherein said display further comprises:
a first sheet of said display having a front and back surface;
a second sheet of said display attached adjacent to said front surface of said first sheet, said second sheet forming a cavity therein for accepting said at least one ticket, wherein said first sheet and second sheet form a container for securing said at least one ticket so that they can not be removed without cutting either said first or second sheet; and
an insert containing indicia relating to said services, wherein said insert is held between said first sheet and second sheet.

21. A system for inducing use of services as defined in claim 20, wherein said first sheet and said second sheet are made of a transparent material.

22. A system for inducing use of services comprising:
at least one ticket for providing a non-date specific service; and
a display for containing said at least one ticket, which comprises advertising related to the services provided by the at least one ticket.

23. A system for inducing use of services as defined in claim 22, further comprising a holder which holds said ticket bearing display for removal from said holder, whereby a retailer induces use of said services to customers viewing said system.

24. A system for inducing use of services as defined in claim 23, wherein said holder is a rod extending substantially perpendicular from a vertical surface.

25. A system for inducing use of services as defined in claim 24, wherein said display includes an aperture for accepting said rod from said holder so that said display is suspended therefrom.

26. A method for obtaining income while advertising a service comprising:
providing at least one ticket-bearing display, which includes at least one ticket for said service, in a system which advertises said service at a retailer location; and
selling said system to said retailer at a cost which permits said retailer to obtain a profit by selling said ticket-bearing display to a consumer.

27. A method according to claim 26, wherein said retailer does not offer said service.

28. A method according to claim 26, wherein said service is offered at one or more fixed locations.

29. A method according to claim 28, wherein said service is offered at more than one fixed location and the locations are identified on the ticket, the display or both.

30. A method according to claim 29, wherein said service is offered at more than one fixed location and the locations are identified by calling a telephone number or visiting an internet web site listed on the ticket, the display or both.

31. A method according to claim 26, wherein said service is selected from the group consisting of an entertainment event, personal care service and property care service.

32. A method according to claim 31, wherein said entertainment event includes customer participation.

33. A method according to claim 32, wherein said entertainment event is selected from the group consisting of a paintball game or competition, skateboarding, in-line skating, roller skating, golf, a driving range, miniature golf, shooting sports, laser tag, theme or amusement parks, horseback riding, skiing, bowling and camping.

34. A method according to claim 33, wherein said service is offered with at least one additional service or good at a cost that is in addition to the cost of said ticket.

35. A method according to claim 34, wherein said consumer is required to purchase of at least one additional service or good at a cost that is in addition to the cost of said ticket, in order to participate in said entertainment event.

36. A method according to claim 35, wherein said entertainment event is a paintball game or competition and said additional service or good is selected from the group consisting of CO₂ cartridges and paintballs.

37. A method according to claim 31, wherein said entertainment event is a spectator event.

38. A method according to claim 37, wherein said entertainment event is selected from the group consisting of sporting events, movies, plays, theatrical or music performances, museums and comedy shows.

39. A method according to claim 38, wherein said spectator event is a date specific event and said ticket is a voucher which can be redeemed for an admission ticket to said date specific event.

40. A method according to claim 31, wherein said personal care service is selected from the group consisting of beauty salon treatments or services and spa treatments.

41. A method according to claim 31, wherein said property care service is selected from automobile care services and pet care services.

42. A method according to claim 26, wherein said ticket is an admission ticket which permits said consumer to enter a facility offering said service or a voucher which can be redeemed for an admission ticket to enter a facility offering said service.

43. A method according to claim 42, wherein said retailer sells said ticket at a price less than the typical entrance fee for said service.

44. A method according to claim 26, wherein said system comprises: (1) said at least one ticket fixed to a display which advertises said service and (2) a holder which holds said ticket bearing display for removal from said holder, whereby said retailer provides said system at a surveillable location for viewing and purchase of said display by said consumer.

45. A method according to claim 44, wherein said display includes multiple tickets.

46. A method according to claim 45, wherein said display includes a group of 5, 10 or 20 tickets.

47. A method according to claim 26, wherein said retailer has a customer base which includes customer demographics suitable for advertising said service.

48. A method according to claim 47, wherein said retailer sells goods that are related to or used in connection with said service.

49. A symbiotic advertising method comprising:
providing at least one ticket-bearing display, which includes at least one ticket for a service, in a system which advertises said service at a retailer location; and
selling said system to said retailer at a cost which permits said retailer to obtain a profit by selling said display to a consumer,
wherein said ticket is applicable to multiple service providers or to no specific service provider.

50. A symbiotic advertising method according to claim 49, wherein said retailer does not offer said service.

51. A symbiotic advertising method according to claim 49, wherein said service provider offers said service at one or more fixed locations.

52. A symbiotic advertising method according to claim 49, wherein said service is selected from the group consisting of an entertainment event, personal care service and property care service.

53. A symbiotic advertising method according to claim 52, wherein said entertainment event includes customer participation.

54. A symbiotic advertising method according to claim 53, wherein said entertainment event is selected from the group consisting of a paintball game or competition, skateboarding, in-line skating, roller skating, golf, a driving range, miniature golf, shooting sports, laser tag, theme or amusement parks, horseback riding, skiing, bowling and camping.

55. A symbiotic advertising method according to claim 53, wherein said service provider offers at least one additional service or good at a cost that is in addition to the cost of said ticket.

56. A symbiotic advertising method according to claim 55, wherein said service provider requires the purchase of at least one additional service or good at a cost that is in addition to the cost of said ticket, in order to participate in said entertainment event.

57. A symbiotic advertising method according to claim 56, wherein said entertainment event is a paintball game or competition and said additional service or good is selected from the group consisting of CO₂ cartridges and paintballs.

58. A symbiotic advertising method according to claim 49, wherein said ticket is an admission ticket which permits said consumer to enter a facility offering said service or a voucher which can be redeemed for an admission ticket to enter a facility offering said service.

59. A symbiotic advertising method according to claim 58, wherein said retailer sells said ticket at a price less than the typical entrance fee for said service.

60. A symbiotic advertising method according to claim 49, wherein said system comprises: (1) said at least one ticket fixed to a display which advertises said service and (2) a holder which holds said ticket bearing display for removal from said holder, whereby said retailer provides said system at a at a surveillable location for viewing and purchase by said consumer.

61. A symbiotic advertising method according to claim 60, wherein said display includes multiple tickets.

62. A symbiotic advertising method according to claim 61, wherein said display includes a group of 5, 10 or 20 tickets.

63. A symbiotic advertising method according to claim 49, wherein said retailer has a customer base which includes customer demographics suitable for advertising said service.

64. A symbiotic advertising method according to claim 63, wherein said retailer sells goods that are related to or used in connection with said service.

65. A symbiotic advertising method according to claim 49, wherein participating service provider locations are identified by calling a telephone number or visiting an internet web site listed on the ticket, the display or both.

66. A symbiotic advertising method according to claim 49, further comprising selling subscriptions to said service providers to participate in said advertising.

67. A method of inducing attendance of an entertainment event comprising:
providing at least one retailer with at least one ticket for said entertainment event at a reduced cost for sale to a consumer whereby said retailer makes a profit based on the sale price to said consumer less said reduced cost, wherein said retailer operates out of one or more fixed locations which are open to the public and which offer for sale other goods or services.

68. A method according to claim 67, wherein said entertainment event is a spectator event selected from the group consisting of sporting events, movies, plays, theatrical or music performances, museums and comedy shows.

69. A method according to claim 68, wherein said ticket is an admission ticket to said event.

70. A method according to claim 69, wherein said ticket is a general admission ticket.

71. A method according to claim 69, wherein said event is held at a specific venue and said ticket permits access to specific locations within said venue.

72. A method according to claim 71, wherein said sale price of said ticket varies depending on the locations to which said ticket permits access.

73. A method according to claim 68, wherein said ticket is a voucher that can be redeemed for an admission ticket to a date specific event.

74. A method according to claim 73, wherein said admission ticket is for an assigned seat.

75. A method according to claim 74, wherein said sale price of said voucher varies depending on the location of the assigned seats.

76. A method according to claim 73, wherein said sale price of said voucher varies depending on the anticipated popularity of the event.

77. A method according to claim 73, wherein said date specific event is a sporting event.
